(19) United States
(12) Patent Application Publication
(10) Pub. No.: US 2004/0222284 A1
(43) Pub. Date: Nov. 11, 2004

(54) Means for protecting an automatic money handling machine or a computer

(76) Inventors: Akito Yamamoto, Yaizu-shi (JP); Hiroyuki Hagiwara, Shiuoka-shi (JP)

Correspondence Address: John S. Egbert, Harrison & Egbert, 7th Floor, 412 Main St., Houston, TX, 77002, US

(21) Appl. No.: 10/628,038

(22) Filed: Jul. 28, 2003

(30) Foreign Application Priority Data
May 8, 2003 (JP) 2003-130076
May 22, 2003 (JP) 2003-144546

(51) Int. Cl. G06F 17/60

(52) U.S. Cl. 235/379

(57) ABSTRACT

A protecting device for an automatic money handling machine, includes an upper surface of the automatic money handling machine being formed flat, a base plate, a housing space for housing the automatic money handling machine being formed under the base plate, the base plate having an opening through which the automatic money handling machine is passed, and the opening continuing to the housing space. The automatic money handling machine is usually held over the opening by a supporting device so as to protrude above the base plate. The supporting function of the supporting device is cancelable. The automatic money handling machine drops downwardly into the housing space so as not to protrude above the base plate when the supporting function of the supporting device is canceled. It is impossible to take away money contained in the automatic money handling machine even by means of heavy construction or destruction machines.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a means for protecting an automatic money handling machine or a computer. The automatic money handling machine automatically receives and/or delivers bills and/or coins. The automatic money handling machine includes an automatic teller machine and a vending machine. More particularly, the invention relates to a means for preventing money contained in the automatic money handling machine from being taken by force, or a means for protecting data contained in a computer, particularly a large computer, from being damaged by an earthquake or a fire.

At present, automatic money handling machines are installed within or near the buildings of banking organs, supermarkets, convenience stores, railway stations, department stores, etc. Also, many automatic money handling machines are installed by the roadside or within independent roadside buildings.

### BACKGROUND OF THE INVENTION

Japanese Patent Laid-Open Publication No. 2001-351144 and Japanese Patent Laid-Open Publication No.2002-8094 disclose means for protecting an automatic teller machine.

The means for protecting an automatic teller machine disclosed by said publications comprises a protection wall surrounding said automatic teller machine, said protection wall protecting an inspection door of said automatic teller machine so as to prevent money contained in the automatic teller machine from being taken by force.

Recently, there have been many crimes that automatic money handling machines are broken or brought away by means of heavy construction or destruction machines equipped on each side with a continuous roller belt over cogged wheels in order to obtain money contained in the automatic money handling machines.

However, the means for protecting an automatic teller machine disclosed by said publications merely protects the inspection door of the automatic teller machine by the protection wall surrounding the automatic teller machine. Said means is not intended for protecting the automatic teller machine from being broken or brought away by means of the heavy construction or destruction machines. Therefore, said means cannot prevent the above-mentioned crimes that automatic money handling machines are broken or brought away by means of the heavy construction or destruction machines in order to obtain money contained in the automatic money handling machines.

### BRIEF SUMMARY OF THE INVENTION

It is an object of the present invention to protect an automatic money handling machine from the crimes that the automatic money handling machine is broken or brought away by means of heavy construction or destruction machines equipped on each side with a continuous roller belt over cogged wheels in order to obtain money contained in the automatic money handling machine.

It is another object of the present invention to protect a computer from being damaged by an earthquake or a fire.

These and other objects have been achieved by the following means for protecting an automatic money handling machine or a computer.

First, the present invention is a means for protecting an automatic money handling machine, comprising an upper surface of said automatic money handling machine being formed flat, a base plate, a housing space for housing said automatic money handling machine being formed under said base plate, said base plate having an opening through which said automatic money handling machine is passed, said opening continuing to said housing space, said automatic money handling machine being usually held over said opening by a supporting means so as to protrude above said base plate, the supporting function of said supporting means being cancelable, said automatic money handling machine dropping downwardly into said housing space so as not to protrude above said base plate when the supporting function of said supporting means is canceled.

In this embodiment, the automatic money handling machine is usually held over the opening of the base plate by the supporting means so as to protrude above the base plate.

When there is a fear of the automatic money handling machine being broken or brought away by means of a heavy construction or destruction machine equipped on each side with a continuous roller belt over cogged wheels, the fear is detected by means of a sensor, for example. The sensor gives a signal for canceling the supporting function of the supporting means of holding the automatic money handling machine over the opening of the base plate. Then the automatic money handling machine drops downwardly into the housing space so that the automatic money handling machine does not protrude above said base plate. This means that the flat upper surface of the automatic money handling machine is at a height substantially equal to or lower than the upper surface of the base plate. When the flat upper surface of the automatic money handling machine is at a height substantially equal to or lower than the upper surface of the base plate, then it is not possible to break or bring away the automatic money handling machine even by means of a heavy construction or destruction machine. Thus, money contained in the automatic money handling machine cannot be taken away.

Second, in the means for protecting an automatic money handling machine described above, the automatic money handling machine may be surrounded by a protection wall fixed on said base plate.

In this embodiment, persons standing near the automatic money handling machine are protected from the machine dropping downwardly into the housing space.

Third, the present invention is a means for protecting an automatic money handling machine, comprising a building containing said automatic money handling machine, said building having a flat upper surface, a base plate, a housing space for housing said building being formed under said base plate, said base plate having an opening through which said building is passed, said opening continuing to said housing space, said building being usually held over said opening by a supporting means so as to protrude above said base plate, the supporting function of said supporting means being cancelable, said building dropping downwardly into said housing space together with said automatic money handling machine so that said building does not protrude above said base plate when the supporting function of said supporting means is canceled.

In this embodiment, the building containing the automatic money handling machine is usually held over the opening of the base plate by the supporting means so as to protrude above the base plate.

When there is a fear of the automatic money handling machine being broken or brought away by means of a heavy construction or destruction machine equipped on each side with a continuous roller belt over cogged wheels, the fear is detected by means of a sensor, for example. The sensor gives a signal for canceling the supporting function of the supporting means of holding the building over the opening of the base plate. Then the building drops downwardly into the housing space together with the automatic money handling machine so that the building does not protrude above the base plate. This means that the flat upper surface of the building is at a height substantially equal to or lower than the upper surface of the base plate. When the flat upper surface of the building is at a height substantially equal to or lower than the upper surface of the base plate, then it is not possible to break or bring away the automatic money handling machine even by means of a heavy construction or destruction machine. Thus, money contained in the automatic money handling machine cannot be taken away.

Fourth, the present invention is a means for protecting an automatic money handling machine, comprising an upper surface of said automatic money handling machine being formed flat, a base plate, a housing space for housing said automatic money handling machine being formed under said base plate, said base plate having an opening through which said automatic money handling machine is passed, said opening continuing to said housing space, said automatic money handling machine being usually held over said opening so as to protrude above said base plate, and a vertically moving means for vertically moving said automatic money handling machine between a position in which said automatic money handling machine is held over said opening so as to protrude above said base plate and another position in which said automatic money handling machine is housed within said housing space so as not to protrude above said base plate.

In this embodiment, the automatic money handling machine is usually held over the opening of the base plate so as to protrude above the base plate.

At a closing hour of the automatic money handling machine or when there is a fear of the automatic money handling machine being broken or brought away by means of a heavy construction or destruction machine, the automatic money handling machine is moved downwardly by the vertically moving means to said another position in which the automatic money handling machine is housed within the housing space so as not to protrude above said base plate. At a closing hour of the automatic money handling machine, the vertically moving means is actuated by a timer, for example. When there is a fear of the automatic money handling machine being broken or brought away by means of a heavy construction or destruction machine, the fear is detected by means of a sensor, for example, and the sensor gives a signal for actuating the vertically moving means. Then, the automatic money handling machine is moved downwardly to said another position in which the flat upper surface of the automatic money handling machine is at a height substantially equal to or lower than the upper surface of the base plate. Therefore, it is not possible to break or bring away the automatic money handling machine even by means of a heavy construction or destruction machine. Thus, money contained in the automatic money handling machine cannot be taken away.

When the automatic money handling machine is to be used again, the machine is moved upwardly to said position in which the machine is held over the opening so as to protrude above the base plate.

Fifth, in the means for protecting an automatic money handling machine described above, the automatic money handling machine may be surrounded by a protection wall fixed on said base plate.

In this embodiment, persons standing near the automatic money handling machine are protected from the machine moving downwardly into the housing space.

Sixth, the present invention is a means for protecting an automatic money handling machine, comprising a building containing said automatic money handling machine, said building having a flat upper surface, a base plate, a housing space for housing said building being formed under said base plate, said base plate having an opening through which said building is passed, said opening continuing to said housing space, said building being usually held over said opening so as to protrude above said base plate, and a vertically moving means for vertically moving said building between a position in which said building is held over said opening so as to protrude above the base plate and another position in which said building is housed within said housing space so as not to protrude above said base plate.

In this embodiment, the building containing the automatic money handling machine is usually held over the opening of the base plate by the supporting means so as to protrude above the base plate.

At a closing hour of the automatic money handling machine or when there is a fear of the automatic money handling machine being broken or brought away by means of a heavy construction or destruction machine, the building containing the automatic money handling machine is moved downwardly by the vertically moving means to said another position in which the building is housed within the housing space so as not to protrude above said base plate. At a closing hour of the automatic money handling machine, the vertically moving means is actuated by a timer, for example. When there is a fear of the automatic money handling machine being broken or brought away by means of a heavy construction or destruction machine, the fear is detected by means of a sensor, for example, and the sensor gives a signal for actuating the vertically moving means. Then, the building is moved downwardly to said another position in which the flat upper surface of the building is at a height substantially equal to or lower than the upper surface of the base plate. Therefore, it is not possible to break or bring away the automatic money handling machine even by means of a heavy construction or destruction machine. Thus, money contained in the automatic money handling machine cannot be taken away.

When the automatic money handling machine is to be used again, the building containing the automatic money handling machine is moved upwardly to said position in which the machine is held over said opening so as to protrude above the base plate.

Seventh, the present invention is a means for protecting an automatic money handling machine, comprising a protection container disposed near said automatic money handling machine, said automatic money handling machine being movable into said protection container.

At a closing hour of the automatic money handling machine or when there is a fear of the automatic money handling machine being broken or brought away by means of a heavy construction or destruction machine, the automatic money handling machine is moved into the protection container.

When the automatic money handling machine is to be used again, the machine is moved out of the protection container to the original position.

Eighth, the present invention is a means for protecting an automatic money handling machine, comprising said automatic money handling machine being installed on a base plate, a money container in said automatic money handling machine having a flat upper surface, a housing space for housing said money container being formed under said base plate, said base plate having an opening through which said money container is passed, said opening continuing to said housing space, said money container being usually held over said opening and in a proper position within said automatic money handling machine by a supporting means, the supporting function of said supporting means being cancelable, said money container dropping downwardly into said housing space so as not to protrude above said base plate when the supporting function of said supporting means is canceled.

In this embodiment, the money container is usually held over the opening and in a proper position within the automatic money handling machine by a supporting means.

When there is a fear of the automatic money handling machine being broken or brought away by means of a heavy construction or destruction machine equipped on each side with a continuous roller belt over cogged wheels, the fear is detected by means of a sensor, for example. The sensor gives a signal for canceling the supporting function of the supporting means of holding the money container over the opening of the base plate and in a proper position within the automatic money handling machine. Then the money container drops downwardly into the housing space so as not to protrude above the base plate. This means that the flat upper surface of the money container is at a height substantially equal to or lower than the upper surface of the base plate. When the flat upper surface of the money container is at a height substantially equal to or lower than the upper surface of the base plate, then it is not possible to break or bring away the money container by means of a heavy construction or destruction machine even if the automatic money handling machine has been broken or removed by means of the heavy construction or destruction machine. Thus, money contained in the money container cannot be taken away.

Ninth, the present invention is a means for protecting an automatic money handling machine, comprising said automatic money handling machine being installed on a base plate, a money container in said automatic money handling machine having a flat upper surface, a housing space for housing said money container being formed under said base plate, said base plate having an opening through which said money container is passed, said opening continuing to said housing space, said money container being usually held over said opening and in a proper position within said automatic money handling machine, and a vertically moving means for vertically moving said money container between said proper position within said automatic money handling machine and another position in which said money container is housed within said housing space so as not to protrude above said base plate.

In this embodiment, the money container is usually held in a proper position within the automatic money handling machine.

At a closing hour of the automatic money handling machine or when there is a fear of the automatic money handling machine being broken or brought away by means of a heavy construction or destruction machine, the money container is moved downwardly by the vertically moving means to said another position in which the money container is housed within the housing space so as not to protrude above said base plate. At a closing hour of the automatic money handling machine, the vertically moving means is actuated by a timer, for example. When there is a fear of the automatic money handling machine being broken or brought away by means of a heavy construction or destruction machine, the fear is detected by means of a sensor, for example, and the sensor gives a signal for actuating the vertically moving means. Then, the money container is moved downwardly to said another position in which the flat upper surface of the money container is at a height substantially equal to or lower than the upper surface of the base plate. Therefore, it is not possible to break or bring away the money container by means of a heavy construction or destruction machine even if the automatic money handling machine has been broken or removed by means of the heavy construction or destruction machine. Thus, money contained in the money container cannot be taken away.

When the automatic money handling machine is to be used again, the money container is moved upwardly to the original position within the automatic money handling machine by the vertically moving means.

Tenth, the present invention is a means for protecting an automatic money handling machine, comprising a money container of said automatic money handling machine being disposed in a place away from said automatic money handling machine, said money container being connected with said automatic money handling machine by a money conveying means.

In this embodiment, the money container is not disposed within the automatic money handling machine. The money container is disposed in a place away from the automatic money handling machine. When the user of the automatic money handling machine operates the machine, money is conveyed between the automatic money handling machine and the money container.

Since the money container is disposed in a place away from the automatic money handling machine, the money container or money contained therein cannot be taken away even when the automatic money handling machine has been broken or moved away by means of a heavy construction or destruction machine.

Eleventh, the present invention is a means for protecting an automatic money handling machine, comprising a money container of said automatic money handling machine being disposed in the ground on the outside of said automatic money handling machine, said money container being connected with said automatic money handling machine by a money conveying means.

In this embodiment, the money container is not disposed within the automatic money handling machine. The money container is disposed in the ground on the outside of said automatic money handling machine. When the user of the automatic money handling machine operates the machine, money is conveyed between the automatic money handling machine and the money container.

Since the money container is disposed in the ground, the money container or money contained therein cannot be taken away even when the automatic money handling machine has been broken or moved away by means of a heavy construction or destruction machine.

Twelfth, the present invention is a means for protecting an automatic money handling machine, comprising a base plate, a housing space for housing said automatic money handling machine being formed under said base plate, said base plate having an opening through which said automatic money handling machine is passed, said opening continuing to said housing space, said automatic money handling machine being usually held over said opening by a supporting means so that said automatic money handling machine protrudes above said base plate and the bottom of said automatic money handling machine is higher than said base plate, the supporting function of said supporting means being cancelable, said automatic money handling machine dropping downwardly into said housing space so as not to protrude above said base plate when the supporting function of said supporting means is canceled, said automatic money handling machine being surrounded by a wall, a part of said wall being adapted to cover said opening after said automatic money handling machine drops downwardly into said housing space.

In this embodiment, at a closing hour of the automatic money handling machine or when there is a fear of the automatic money handling machine being broken or brought away by means of a heavy construction or destruction machine, the automatic money handling machine drops downwardly into the housing space and then a part of the wall covers the opening. Therefore, it is not possible to break or bring away the automatic money handling machine even by means of the heavy construction or destruction machine. Thus, money contained in the money container cannot be taken away.

Since the automatic money handling machine is usually held over the opening so that the bottom of said automatic money handling machine is higher than said base plate, the housing space for housing the automatic money handling machine can be made shallower.

Thirteenth, the present invention is a means for protecting an automatic money handling machine, comprising a base plate, a housing space for housing said automatic money handling machine being formed under said base plate, said base plate having an opening through which said automatic money handling machine is passed, said opening continuing to said housing space, said automatic money handling machine being usually held in a position over said opening in which position said automatic money handling machine protrudes above said base plate and the bottom of said automatic money handling machine is higher than said base plate, a vertically moving means for vertically moving said automatic money handling machine between said position and another position in which said automatic money handling machine is housed within said housing space so as not to protrude above said base plate, said automatic money handling machine being surrounded by a wall, a part of said wall being adapted to cover said opening after said automatic money handling machine moves downwardly into said housing space.

In this embodiment, the automatic money handling machine is moved downwardly into the housing space and moved upwardly to the original position by the vertically moving means.

Fourteenth, the present invention is a means for protecting a computer, comprising a base plate, a housing space for housing said computer being formed under said base plate, said base plate having an opening through which said computer is passed, said opening continuing to said housing space, said computer being usually held over said opening so as to protrude above said base plate, a vertically moving means for vertically moving said computer between a position in which said computer is held over said opening so as to protrude above said base plate and another position in which said computer is housed within said housing space so as not to protrude above said base plate, a protection plate being disposed near said opening, said protection plate being adapted to cover said opening after said computer moves downwardly into said housing space.

In this embodiment, a computer, particularly a large computer, and data contained therein are protected from being damaged by an earthquake or a fire.

When an earthquake or a fire is detected by a sensor, for example, the sensor gives signals for actuating the vertically moving means and moving the protection plate so as to cover the opening. Then, the computer is moved downwardly to said another position in which the computer is housed within the housing space so as not to protrude above said base plate, and the protection plate covers the opening. Therefore, the computer and data contained therein are free from damage by the earthquake or the fire.

Thus, according to the present invention, it is impossible to take away money contained in the automatic money handling machine even by means of heavy construction or destruction machines equipped on each side with a continuous roller belt over cogged wheels. Furthermore, the computer and data contained therein are protected from being damaged by an earthquake or a fire.

### BRIEF DESCRIPTION OF THE VIEW OF THE DRAWING

FIG. 1 is a perspective view schematically showing a means for protecting an automatic money handling machine according to the present invention.

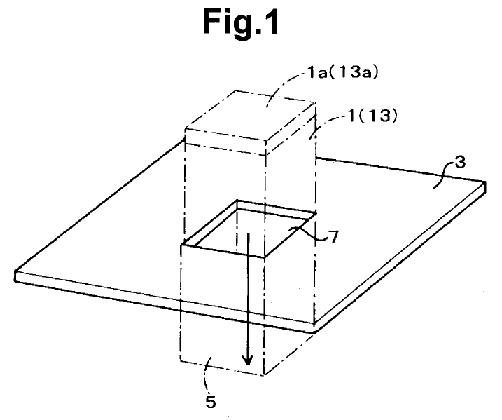

FIG. 2 is a sectional view showing said automatic money handling machine protruding above a base plate.

FIG. 3 is a sectional view showing said automatic money handling machine dropped downwardly into a housing space.

FIG. 4 is a sectional view showing a building containing said automatic money handling machine, said building protruding above the base plate.

FIG. 5 is a sectional view showing said building in FIG. 4 dropped downwardly into the housing space.

FIG. 6 is a sectional view showing said automatic money handling machine housed within a building and protruding above the base plate.

FIG. 7 is a sectional view showing said automatic money handling machine in FIG. 6 housed in the housing space.

FIG. 8 is a sectional view showing said building containing said automatic money handling machine, said building protruding above the base plate.

FIG. 9 is a sectional view showing said building in FIG. 8 housed in the housing space.

FIG. 10 is a sectional view showing said building containing said automatic money handling machine, said building protruding above the base plate.

FIG. 11 is a sectional view showing a money container held in a proper position within said automatic money handling machine.

FIG. 12 is a sectional view showing said money container in FIG. 11 dropped downwardly into the housing space.

FIG. 13 is a sectional view showing a money container held in a proper position within said automatic money handling machine.

FIG. 14 is a sectional view showing said money container in FIG. 13 housed in the housing space.

FIG. 15 is a sectional view showing the money container disposed in the ground on the outside of said automatic money handling machine.

FIG. 16 is a sectional view showing said automatic money handling machine surrounded by a protection wall.

FIG. 17 is a side view showing said automatic money handling machine and a protection container disposed near said automatic money handling machine.

FIG. 18 is a sectional view showing an automatic money handling machine held over the opening.

FIG. 19 is a sectional view showing said automatic money handling machine in FIG. 18 housed in the housing space.

FIG. 20 a sectional view showing a computer held over the opening.

FIG. 21 is a sectional view showing said computer in FIG. 20 housed in the housing space.

### DETAILED DESCRIPTION OF THE INVENTION

The invention will now be described in detail with reference to the attached drawings.

Reference symbol 1 represents an automatic money handling machine.

Similarly to conventional automatic money handling machines, the automatic money handling machine 1 has a CTR display which shows operation procedures by means of letters, figures, etc., a slot for bills, a slot for coins, a slit for cards, a slit for bankbooks, an opening for delivering changes, etc.

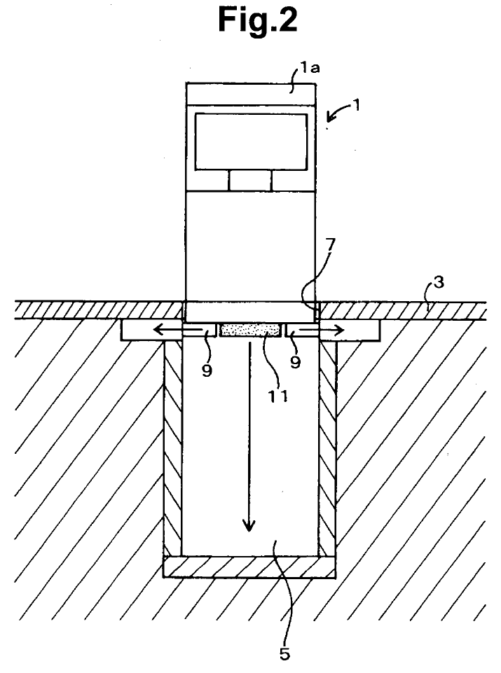

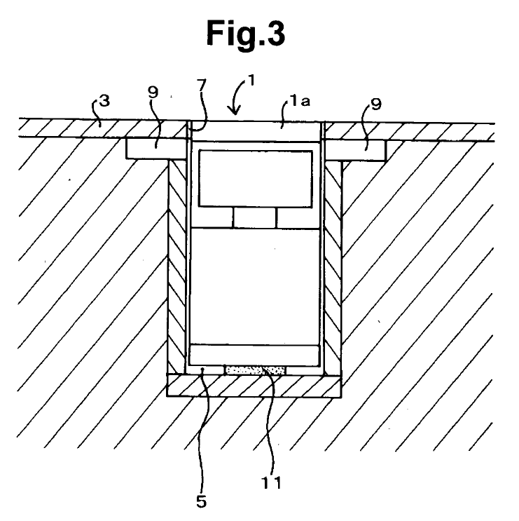

An embodiment shown in FIGS. 2 and 3 will be described. An upper surface of the automatic money handling machine 1 is formed flat. For example, the upper surface of the automatic money handling machine 1 is composed of a firm, flat plate 1a of steel or iron.

Reference symbol 3 represents a base plate. The base plate 3 is composed of a firm, flat plate of steel or iron, for example. A housing space 5 for housing the automatic money handling machine 1 is formed under the base plate 3.

The base plate 3 has an opening 7 through which the automatic money handling machine 1 is passed. The opening 7 continues to the housing space 5.

The automatic money handling machine 1 is usually held over the opening 7 by a supporting means 9 so as to protrude above the base plate 3. The supporting function of the supporting means 9 is cancelable.

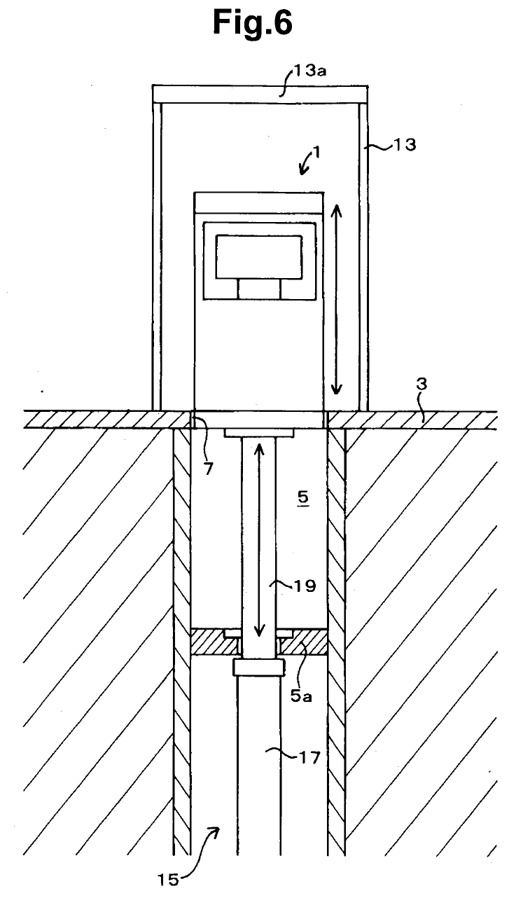

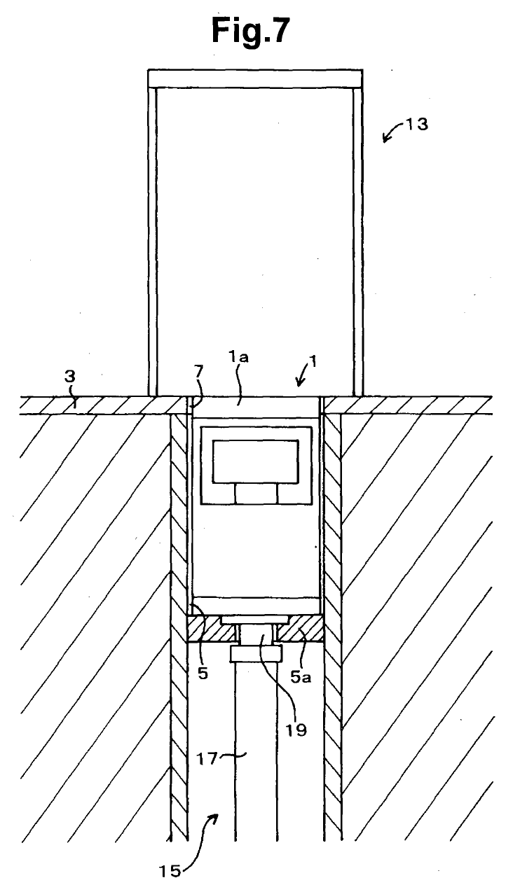

The supporting means 9 may be, for example, vertical hydraulic cylinders as shown in FIGS. 6 and 7. The supporting function of the vertical hydraulic cylinders is canceled when the liquid is removed therefrom.

Also, the supporting means 9 may be, for example, supporting rods or plates which are adapted to protrude from and move into side walls of the housing space 5. When the supporting rods or plates have protruded from the side walls of the housing space 5, the supporting rods or plates hold the automatic money handling machine 1 so as to protrude above the base plate 3. When the supporting rods or plates have moved into the side walls of the housing space 5, the supporting rods or plates no longer have the function of supporting the automatic money handling machine 1.

When the supporting function of the supporting means is canceled, the automatic money handling machine 1 drops downwardly into the housing space 5 so as not to protrude above the base plate 3.

The automatic money handling machine 1 is preferably provided on the bottom thereof with a buffer means 11, such as cushions and springs, which serve to lessen shock when the automatic money handling machine 1 drops downwardly into the housing space 5.

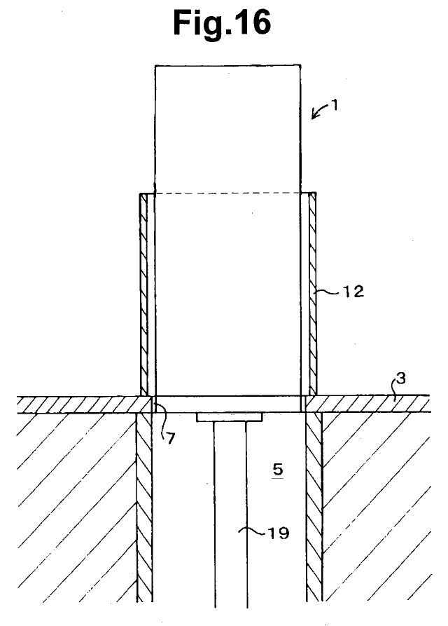

In the means for protecting an automatic money handling machine 1 described above, the automatic money handling machine 1 may be surrounded by a protection wall 12 fixed on said base plate 3. See FIG. 16.

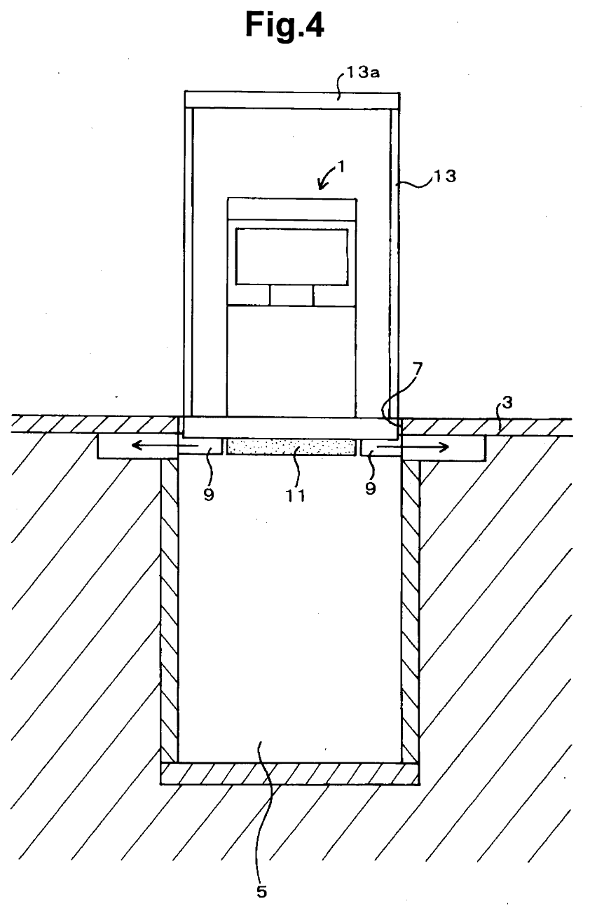

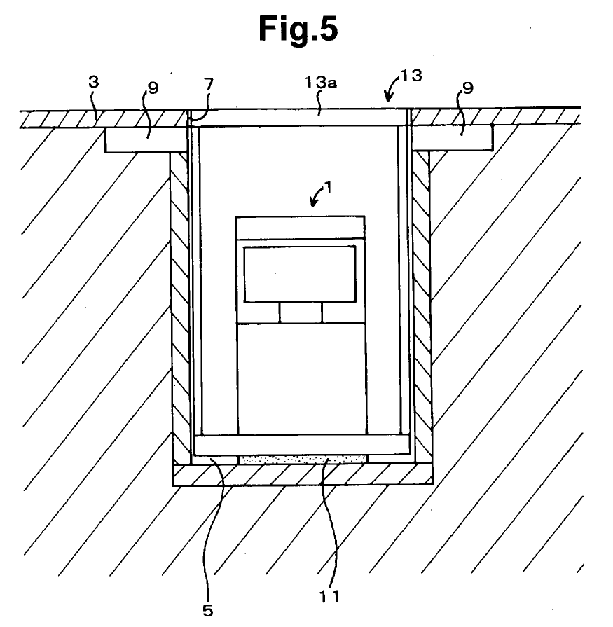

An embodiment shown in FIGS. 4 and 5 will be described. Reference symbol 13 represents a building containing the automatic money handling machine 1. The building 13 has a flat upper surface which is composed of a firm, flat plate 13a of steel or iron, for example.

A housing space 5 for housing the building 13 is formed under the base plate 3. The base plate 3 has an opening 7 through which the building 13 is passed. The opening 7 continues to the housing space 5.

The building 13 is usually held over the opening 7 by a supporting means 9 so as to protrude above the base plate 3. The supporting function of the supporting means 9 is cancelable.

The supporting means 9 may be the same as mentioned above.

The building 13 is preferably provided on the bottom thereof with a buffer means 11, such as cushions and springs, which serve to lessen shock when the building 13 drops downwardly into the housing space 5.

The building 13 drops downwardly into the housing space 5 together with the automatic money handling machine 1 so that the building 13 does not protrude above the base plate 3 when the supporting function of the supporting means 9 is canceled.

An embodiment shown in FIGS. 6 and 7 will be described. The automatic money handling machine 1 is usually held over the opening 7 so as to protrude above the base plate 3. In this embodiment, the automatic money handling machine 1 is vertically moved by a vertically moving means 15 between a position in which the automatic money handling machine 1 is held over the opening 7 so as to protrude above the base plate 3 and another position in which the automatic money handling machine 1 is housed within the housing space 5 so as not to protrude above the base plate 3.

The automatic money handling machine 1 may be usually held over the opening 7 so as to protrude above the base plate 3 by the vertically moving means 15 or by a supporting means having a cancelable supporting function.

The vertically moving means 15 may be hydraulic cylinders 17, for example. In FIGS. 6 and 7, a plunger 19 of the hydraulic cylinder 17 vertically passes through a bottom 5a of the housing space 5.

In the means for protecting an automatic money handling machine 1 described above, the automatic money handling machine 1 may be surrounded by a protection wall 12 fixed on said base plate 3. See FIG. 16.

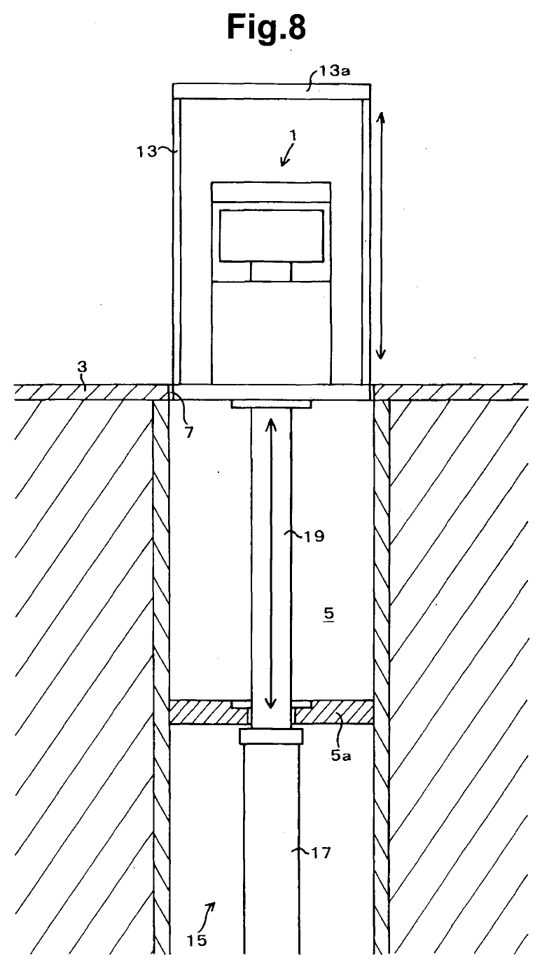

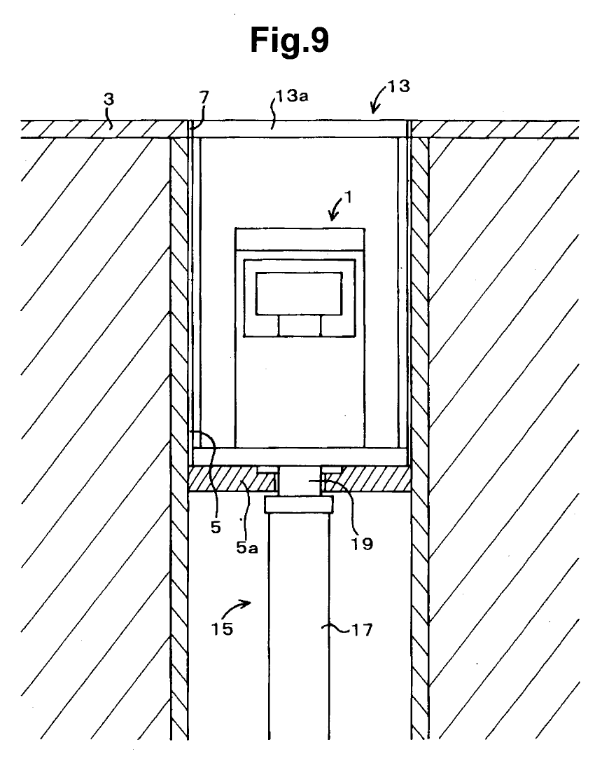

An embodiment shown in FIGS. 8 and 9 will be described. A building 13 containing the automatic money handling machine 1 has a flat upper surface. A housing space 5 for housing the building 13 is formed under the base plate 3. The base plate 3 has an opening 7 through which the building 13 is passed. The opening 7 continues to the housing space 5. The building 13 is usually held over the opening 7 so as to protrude above the base plate 3. The building 13 is vertically moved by a vertically moving means 15 between a position in which the building 13 is held over the opening 7 so as to protrude above the base plate 3 (See FIG. 8.) and another position in which the building 13 is housed within the housing space 5 so as not to protrude above the base plate 3 (See FIG. 9).

The building 13 may be usually held over the opening 7 so as to protrude above the base plate 3 by the vertically moving means 15 or by a supporting means having a cancelable supporting function.

The vertically moving means 15 may be hydraulic cylinders 17, for example. In FIGS. 8 and 9, a plunger 19 of the hydraulic cylinder 17 vertically passes through a bottom 5a of the housing space 5.

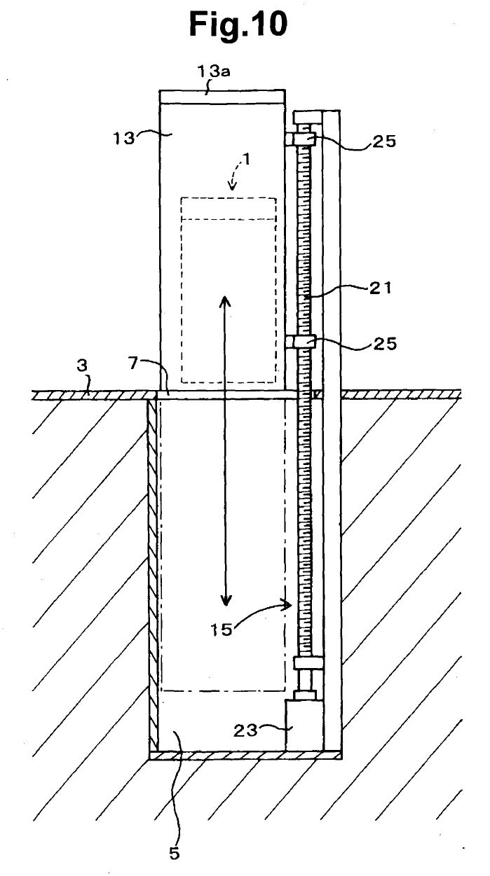

An embodiment shown in FIG. 10 will be described. In this embodiment, a vertically moving means 15 comprises a vertical threaded shaft 21 being rotatable and axially immovable, the threaded shaft 21 being rotated by an electric motor 23, unrotatable nuts 25 being engaged with the threaded shaft 21, the nuts 25 being fixed to the building 13. When the threaded shaft 21 is rotated by the electric motor 23 in a certain direction, the nuts 25 engaged with the threaded shaft 21 move downwardly and lower the building 13. When the threaded shaft 21 is rotated in the opposite direction, the nuts 25 engaged with the threaded shaft 21 move upwardly and raise the building 13.

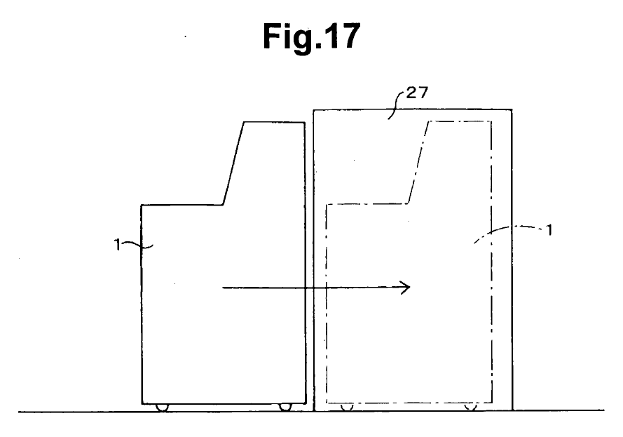

In an embodiment shown in FIG. 17, a firm protection container 27 is disposed near the automatic money handling machine 1. The automatic money handling machine 1 is movable into the protection container 27. The protection container 27 is composed of steel or iron, for example.

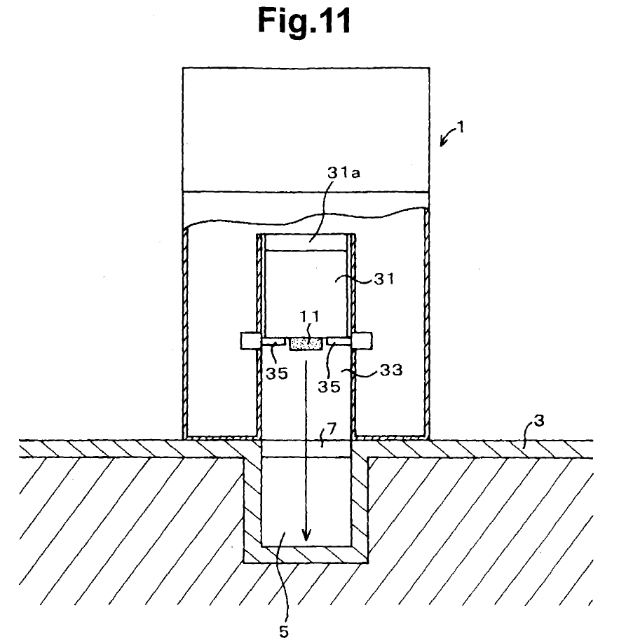

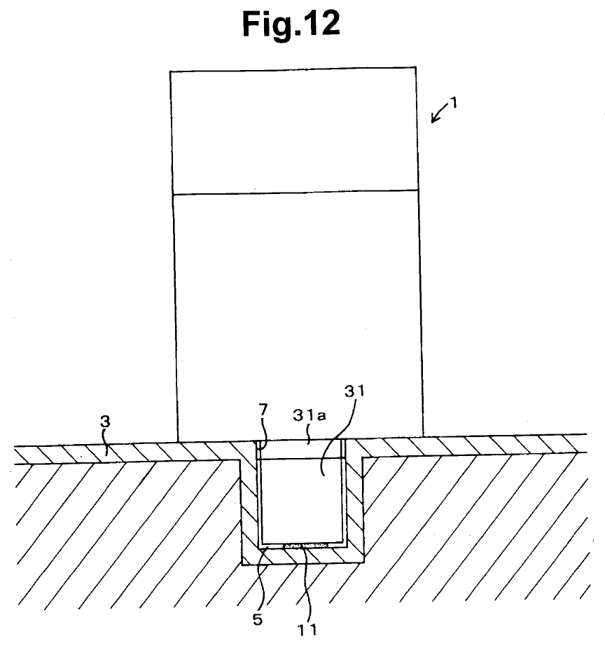

An embodiment shown in FIGS. 11 and 12 will be described. The automatic money handling machine 1 is installed on the base plate 3. The automatic money handling machine 1 has a money container 31. The money container 31 has a flat upper surface which is composed of a firm, flat plate 31a of steel or iron, for example.

A housing space 5 for housing the money container 31 is formed under the base plate 3.

The base plate 3 has an opening 7 through which the money container 31 is passed. The opening 7 continues to the housing space 5.

A passage 33 is disposed within the automatic money handling machine 1. The passage 33 continues to the opening 7 thereunder. Thus, the money container 31 can enter the housing space 5 through the passage 33 and the opening 7.

The money container 31 is usually held over the opening 7 and in a proper position within the automatic money handling machine 1 by a supporting means 35. The supporting function of the supporting means 35 is cancelable.

The supporting means 35 may be, for example, vertical hydraulic cylinders. The supporting function of the vertical hydraulic cylinders is canceled when the liquid is removed therefrom.

Also, the supporting means 35 may be, for example, supporting rods or plates which are adapted to protrude from and move into side walls of the passage 33. When the supporting rods or plates have protruded from the side walls of the passage 33, the supporting rods or plates hold money container 31 in a proper position within the automatic money handling machine 1. When the supporting rods or plates have moved into the side walls of the passage 33, the supporting rods or plates no longer have the function of supporting the money container 31.

The money container 31 drops downwardly into the housing space 5 so as not to protrude above the base plate 3 when the supporting function of the supporting means 35 is canceled.

The money container 31 is preferably provided on the bottom thereof with a buffer means 11, such as cushions and springs, which serve to lessen shock when the money container 31 drops downwardly into the housing space 5.

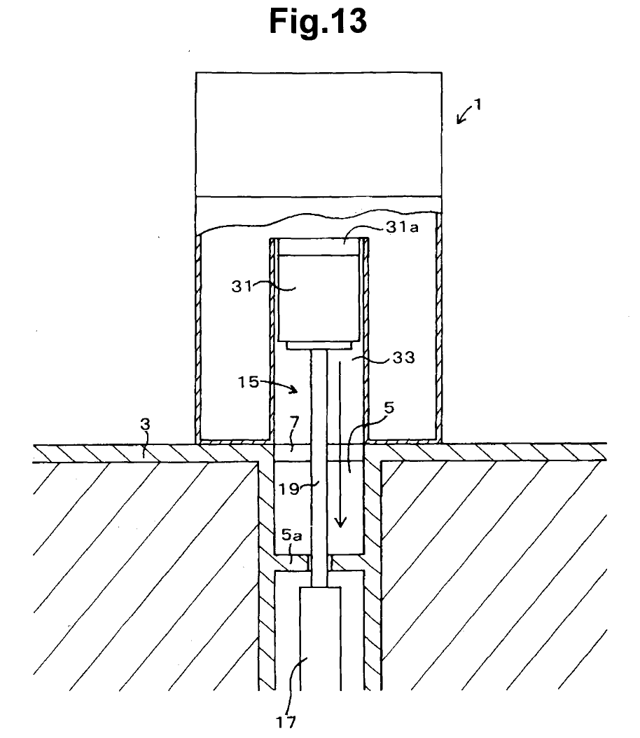

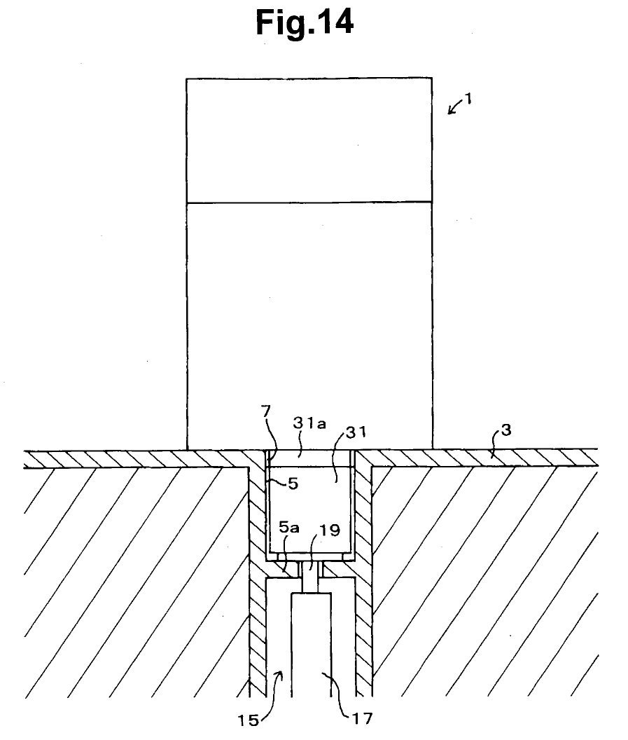

An embodiment shown in FIGS. 13 and 14 will be described. The automatic money handling machine 1 is installed on the base plate 3.

The money container 31 in the automatic money handling machine 1 has a flat upper surface as mentioned above. A housing space 5 for housing the money container 31 is formed under the base plate 3. The base plate 3 has the opening 7 through which the money container 31 is passed. The opening 7 continues to the housing space 5.

The passage 33 is disposed within the automatic money handling machine 1. The passage 33 continues to the opening 7 thereunder. Thus, the money container 31 can enter the housing space 5 through the passage 33 and the opening 7.

The money container 31 is usually held over the opening 7 and in a proper position within the automatic money handling machine 1. In this embodiment, the money container 31 is vertically moved by a vertically moving means 15 between a proper position within the automatic money handling machine 1 and another position in which the money container 31 is housed within the housing space 5 so as not to protrude above the base plate 3.

The money container 31 may be usually held in the proper position within the automatic money handling machine 1 by the vertically moving means 15 or by a supporting means having a cancelable supporting function.

The vertically moving means 15 may be hydraulic cylinders 17, for example. In FIGS. 13 and 14, a plunger 19 of the hydraulic cylinder 17 vertically passes through a bottom 5a of the housing space 5.

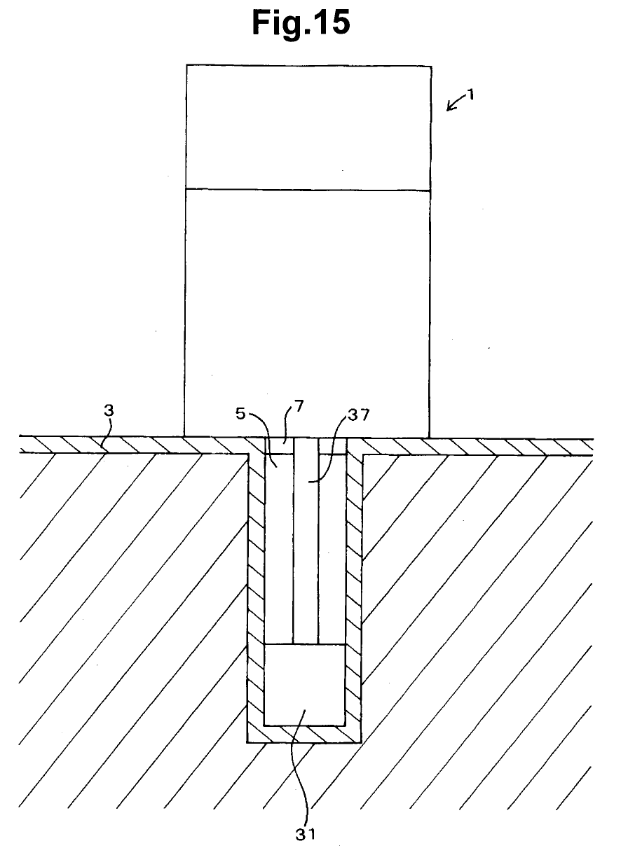

An embodiment shown in FIG. 15 will be described. In this embodiment, the money container 31 of the automatic money handling machine 1 is disposed in a place away from the automatic money handling machine 1, and the money container 31 is connected with the automatic money handling machine 1 by a money conveying means 37.

The money conveying means 37 conveys money between the money container 31 and the automatic money handling machine 1 when the automatic money handling machine 1 is operated.

The money container 31 is preferably disposed in the ground on the outside of the automatic money handling machine 1.

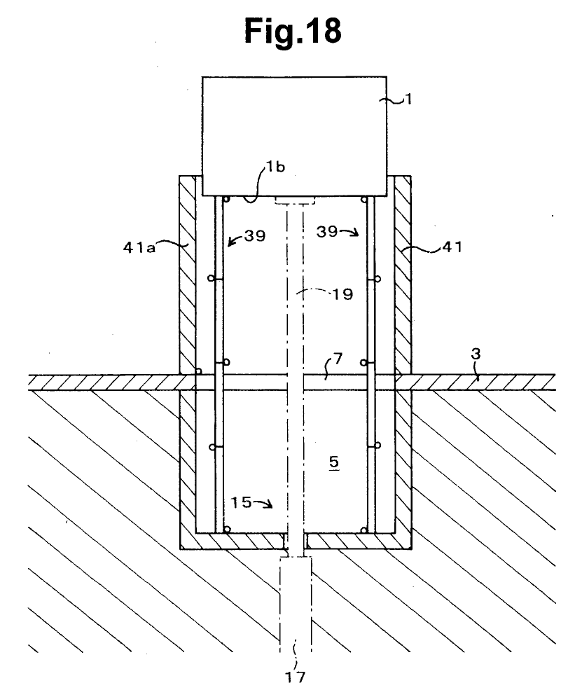

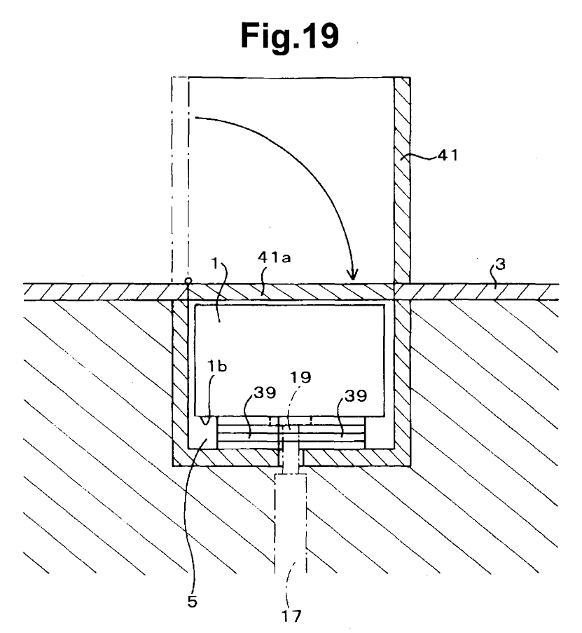

An embodiment shown in FIGS. 18 and 19 will be described. In this embodiment, the automatic money handling machine 1 is usually held over the opening 7 by a supporting means so that the automatic money handling machine 1 protrudes above the base plate 3 and the bottom 1b of the automatic money handling machine 1 is higher than the base plate 3. The supporting function of the supporting means is cancelable.

The supporting means may be folding or telescopic rods 39 or vertical hydraulic cylinders 17, for example. The supporting function of the vertical hydraulic cylinders 17 is canceled when the liquid is removed therefrom.

The automatic money handling machine 1 drops downwardly into the housing space 5 so as not to protrude above the base plate 3 when the supporting function of the supporting means is canceled.

The automatic money handling machine 1 is surrounded by a wall 41. The wall 41 is made of steel or iron, for example. A part 41a of the wall 41 is adapted to cover the opening 7 after the automatic money handling machine 1 drops downwardly into the housing space 5. Said part 41a of the wall 41 may be rotatably attached beside the opening 7.

The automatic money handling machine 1 may be supported by the vertically moving means 15 for vertically moving the automatic money handling machine 1 between said position over the opening 7 in which position the automatic money handling machine 1 protrudes above the base plate 3 and the bottom 1b of the automatic money handling machine 1 is higher than the base plate 3 and another position in which the automatic money handling machine 1 is housed within the housing space 5 so as not to protrude above the base plate 3. The part 41a of said wall 41 is adapted to cover the opening 7 after the automatic money handling machine 1 moves downwardly into the housing space 5.

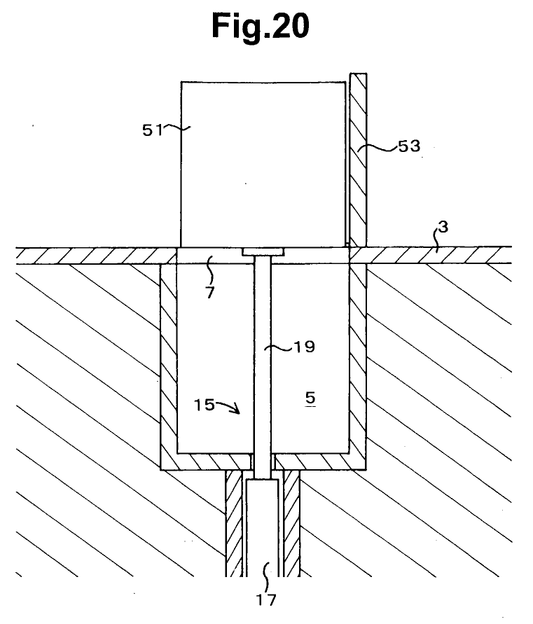

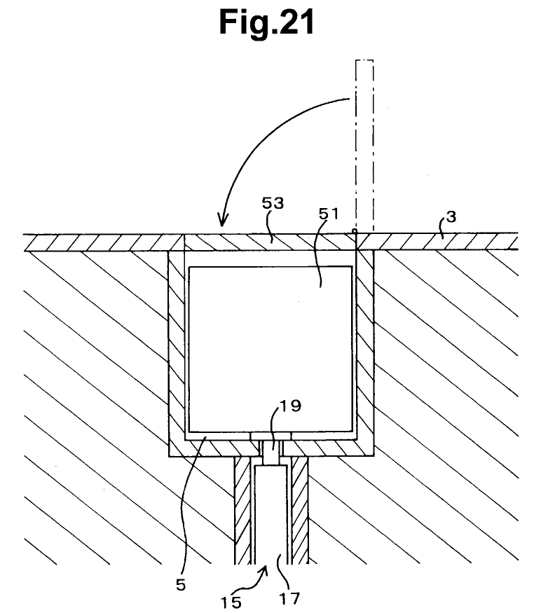

An embodiment shown in FIGS. 20 and 21 will be described.

This embodiment is a means for protecting a computer 51. The housing space 5 for housing the computer 51 is formed under the base plate 3. The computer 51 is usually held over the opening 7 so as to protrude above the base plate 3. The computer 51 may be supported by the vertically moving means 15 for vertically moving the computer 51 between a position in which the computer 51 is held over the opening 7 so as to protrude above the base plate 3 and another position in which the computer 51 is housed within the housing space 5 so as not to protrude above the base plate 3. A protection plate 53 is disposed near the opening 7. The protection plate 53 is adapted to cover the opening 7 after the computer 51 moves downwardly into the housing space 5. The protection plate 53 may be rotatably attached beside the opening 7.

As many apparently widely different embodiments of the present invention may be made without departing from the spirit and scope thereof, it is to be understood that the invention is not limited to the specific embodiments thereof except as defined in the appended claims.

1-14. (canceled)

15. A means for protecting an automatic money handling machine, comprising:
an upper surface of said automatic money handling machine being formed flat;
a base plate; and
a housing space for housing said automatic money handling machine being formed under said base plate, said base plate having an opening through which said automatic money handling machine is passed, said opening continuing to said housing space, said automatic money handling machine being usually held over said opening by a supporting means so as to protrude above said base plate.

16. A means for protecting an automatic money handling machine, according to claim 15, further comprising:
a supporting means with a cancelable supporting function, said automatic money handling machine dropping downwardly into said housing space so as not to protrude above said base plate when the supporting function of said supporting means is canceled.

17. A means for protecting an automatic money handling machine, according to claim 15, wherein said automatic money handling machine is surrounded by a protection wall fixed on said base plate.

18. A means for protecting an automatic money handling machine, according to claim 15, further comprising:
a vertically moving means for vertically moving said automatic money handling machine between a position in which said automatic money handling machine is held over said opening so as to protrude above said base plate and another position in which said automatic money handling machine is housed within said housing space so as not to protrude above said base plate.

19. A means for protecting an automatic money handling machine, according to claim 16, wherein said automatic money handling machine is comprised of a building.

20. A means for protecting an automatic money handling machine, according to claim 17, wherein said automatic money handling machine is comprised of a building.

21. A means for protecting an automatic money handling machine, according to claim 18, wherein said automatic money handling machine is comprised of a building.

22. A means for protecting an automatic money handling machine, comprising:
a protection container disposed near said automatic money handling machine, said automatic money handling machine being movable into said protection container.

23. A means for protecting an automatic money handling machine, according to claim 16, wherein said automatic money handling machine is comprised of a money container with a flat upper surface and wherein said automatic money handling machine is installed on said base plate.

24. A means for protecting an automatic money handling machine, according to claim 18, wherein said automatic money handling machine is comprised of a money container with a flat upper surface and wherein said automatic money handling machine is installed on said base plate.

25. A means for protecting an automatic money handling machine, comprising:
a money container of said automatic money handling machine; and
a money conveying means connecting said money container with said automatic money handling machine.

26. A means for protecting an automatic money handling machine, according to claim 25, wherein said money container is disposed in a place away from said automatic money handling machine

27. A means for protecting an automatic money handling machine, according to claim 25, wherein said money container is disposed in the ground on the outside of said automatic money handling machine.

26. A means for protecting an automatic money handling machine, comprising:
a base plate; and
a housing space for housing said automatic money handling machine being formed under said base plate, said base plate having an opening through which said automatic money handling machine is passed, said opening continuing to said housing space, said automatic money handling machine being usually held over said opening by a supporting means so that said automatic money handling machine protrudes above said base plate and the bottom of said automatic money handling machine is higher than said base plate.

27. A means for protecting an automatic money handling machine, according to claim 26, further comprising:
a supporting means with a cancelable supporting function, said automatic money handling machine dropping downwardly into said housing space so as not to protrude above said base plate when the supporting function of said supporting means is canceled, said automatic money handling machine being surrounded by a wall, a part of said wall being adapted to cover said opening after said automatic money handling machine drops downwardly into said housing space.

28. A means for protecting an automatic money handling machine, according to claim 26, further comprising:
a vertically moving means for vertically moving said automatic money handling machine between said position and another position in which said automatic money handling machine is housed within said housing space so as not to protrude above said base plate, said automatic money handling machine being surrounded by a wall, a part of said wall being adapted to cover said opening after said automatic money handling machine moves downwardly into said housing space.

29. A means for protecting a computer, comprising:
a base plate; and
a housing space for housing said computer being formed under said base plate, said base plate having an opening through which said computer is passed, said opening continuing to said housing space, said computer being usually held over said opening so as to protrude above said base plate, a vertically moving means for vertically moving said computer between a position in which said computer is held over said opening so as to protrude above said base plate and another position in which said computer is housed within said housing space so as not to protrude above said base plate, a protection plate being disposed near said opening, said protection plate being adapted to cover said opening after said computer moves downwardly into said housing space.
